(19) United States
(12) Patent Application Publication
(10) Pub. No.: US 2018/0304866 A1
(43) Pub. Date: Oct. 25, 2018

(54) HAND-HELD CAR WINDOW CLEANING TOOL

(71) Applicant: Life Safety Products B.V., Zoetermeer (NL)

(72) Inventor: Bart VERBAKEL, Zoetermeer (NL)

(21) Appl. No.: 15/491,695

(22) Filed: Apr. 19, 2017

(51) Int. Cl. B60S 3/04; B08B 1/00

(52) U.S. Cl. CPC B60S 3/045; B08B 1/005; B08B 1/003

(57) ABSTRACT

A hand-held car window cleaning tool. The tool comprises a frame part and a handle attached to said frame part. The frame part is provided with at least one of a scraper blade for removing frost, ice or snow; a squeegee blade for removing liquid, dirt or snow; and a sponge. The hand-held cleaning tool is arranged such that the position of the frame part is adjustable with respect to the handle.

### BACKGROUND

This disclosure relates to the field of hand-held car window cleaning tools. More in particular, the disclosure relates to hand-held car window cleaning tools comprising at least one of a scraper blade for removing frost, ice or snow; a squeegee blade for removing liquid, dirt or snow; and a sponge.

Car window cleaning tools can be used to clean windows, as well as other car surfaces, such as exterior mirrors. This may reduce safety hazards, as driving with dirty snowy or icy windows or mirrors can be a huge safety hazard.

There are many different hand-held car window cleaning tools. For example, there is a tool having a plastic, triangular, plate-like main part having three edges, two of which are provided with a scraper blade and a third one of which is provided with a squeegee blade. However, such tools will often not allow one to easily clean an entire window. For example, areas of a window located further away from the sides of a car, such as for instance a central area of a windshield, may be difficult to reach, especially when the user does not have very long arms.

Moreover, existing hand-held car window cleaning tools are often relatively difficult to handle, in particular in severe weather conditions, and/or when a user is wearing gloves.

There exists a need for an alternative hand-held car window cleaning tool, in particular a hand-held car window cleaning tool that can be relatively easy to handle, and/or which can facilitate cleaning a car window in a relatively easy manner.

More in particular, there is a need to provide a hand-held car window cleaning tool which may be used to clean surface areas located relatively far away from a user of the tool, and which can be handled relatively easily, both when cleaning such relatively remote car surface areas, as well as when cleaning car surface areas located relatively nearby the user, in particular wherein said tool further can counteract that its user will accidently damage the car while using the tool, and/or wherein said tool can be stored relatively easily.

### SUMMARY

The present disclosure provides a hand-held car window cleaning tool having a frame part provided with at least one of: a scraper blade for removing frost, ice or snow; a squeegee blade for removing liquid, dirt or snow; and a sponge, wherein said tool further has a handle attached to said frame part, and wherein the hand-held cleaning tool is arranged such that the position of the frame part is adjustable with respect to the handle.

By making the position of the frame part adjustable, it can be tilted with respect to the handle. As a result, the position of a respective utensil, e.g. the squeegee blade, the scraper blade or the sponge, can be changed with respect to the handle, and may for instance be located in line with an elongate direction of the handle when relatively much force has to be applied to said utensil, but may for instance also be located away from said elongate direction of the handle in case the tool is to be used to clean a relatively remote surface area, e.g. a central area of a moon roof. By temporarily offsetting the utensil to be used from the handle, it may be counteracted that the handle accidently bumps into the car and causes damage.

In some embodiments, the frame part may be adjustable with respect to the handle about multiple pivot axes. As a result thereof, it may for instance not only be facilitated that the frame part may be tilted to bring a cleaning utensil relatively close to the center line of the handle, but it can then for instance also be facilitated that another one of the multiple cleaning utensils may instead be brought to such a position relatively close to said center line of the handle.

The frame part may, in some embodiments, be lockable with respect to the handle. Preferably, in case the frame part can be adjusted with respect to the handle about multiple pivot axes, a single lock may allow locking the frame parts with respect to at least two pivot axes.

In some embodiments, the handle may be a telescopic handle that can be expanded and retracted as desired.

### BRIEF DESCRIPTION OF THE DRAWINGS

FIG. 1 shows a schematic perspective view of an embodiment of a hand-held car window cleaning tool with an adjustable frame part being in a first position thereof.

FIG. 2 shows a schematic perspective view of the hand-held car window cleaning tool of FIG. 1 with its sponge detached and its frame part positioned in a second position.

FIG. 3 shows a schematic side view of the hand-held car window cleaning tool of FIG. 1 with its frame part in same position as in FIG. 1.

FIG. 4 shows a schematic side view of the hand-held car window cleaning tool of FIG. 1 with its frame part located in an intermediate adjustment position between the first position and the second position.

FIG. 5 shows a schematic side view of the cleaning tool of FIG. 1 with its frame part located in the second position just like in FIG. 2.

FIG. 6 shows another schematic perspective view of the cleaning tool of FIG. 1 with its frame part located in the second position just like in FIG. 2 and in FIG. 5.

FIG. 7 shows a schematic perspective exploded view of the cleaning tool of FIG. 1.

FIG. 8 shows a schematic perspective view of the cleaning tool of FIG. 1 with its frame part located in the first position just like in FIG. 1 and in FIG. 3 and with its handle in an extended position thereof.

FIG. 9 shows a schematic cross-sectional view of the extended handle of the tool shown in FIG. 8.

### DETAILED DESCRIPTION

It is noted that the figures show merely a preferred embodiment according to the invention. In the figures, the same or similar reference signs or numbers refer to equal or corresponding parts. The following is a detailed description of exemplary embodiments to illustrate the principles of the invention. The described embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention and its embodiments. However, the invention may be practiced according to the claims without some or all of these specific details. For the purpose of clarity, technical material that is known in the technical fields related to the invention has not been described in detail so that the invention is not unnecessarily obscured.

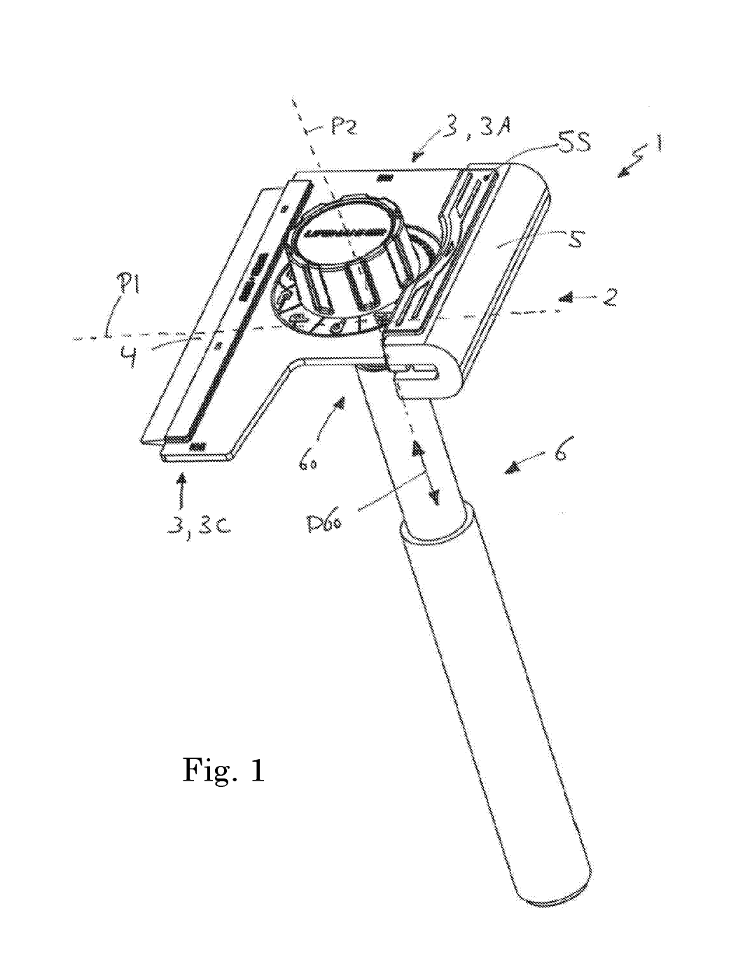

FIG. 1 illustrates an embodiment of a hand-held car window cleaning tool 1. The tool 1 comprises a frame part 2, which is provided with cleaning utensils 3, 4, 5. It is noted that the frame part 2 may be provided with at least one of a scraper blade 3, a squeegee blade 4, and a sponge 5. In preferred embodiments, the frame part may be provided with at least two of a scraper blade 3, a squeegee blade 4, and a sponge 5, in particular at least a scraper blade 3 and a squeegee blade 4. Preferably, the tool 1 may be provided with at least a scraper, a squeegee blade and a sponge, for example to facilitate that the tool 1 may be used the entire year, regardless of the season or weather condition.

The frame part 2 may be considered as a main body part of the cleaning tool 1 or so-called car window cleaner. For example, the frame part 2 may have a relatively flat design, in particular it may have a substantially plate shaped design. The frame part may for example be made of a plastic material. Additionally or alternatively, it may be substantially transparent or substantially translucent, e.g. in order to counteract that the tool 1 will block the view of the user to a too great extent. One or more scraper blades 3, if any, may for example be formed by an edge portion of the frame part 2, in particular when said frame part 2 is relatively flat. Here, the scraper blade, e.g. an ice scraper, is formed by a straight edge or ridge, which for example may be used to break up a sheet of ice. However, in alternative embodiments, the ice scraper may have a different design. For example, the ice scraper could be provided with fingers, e.g. to break up thick ice. The ice scraper may have a notched, serrated or crenellated edge.

The scraper blade 3 may be intended and/or used for removing frost, ice and/or snow, for instance from a car window or windshield. The squeegee blade 4, which may comprise and/or be made of rubber or a rubber like material, may be intended and/or used for removing liquid, dirt and/or snow, for instance from a car window or windshield. Said squeegee blade may form a wiper. The sponge 5 may be intended to wash dirt off, for instance from a car window, car light or windshield. It will be appreciated that the hand-held car window cleaning tool 1 and/or a respective cleaning utensils 3, 4, 5 thereof may additionally or alternatively be used for cleaning other car surfaces, such as for example mirrors, license plates and/or other car parts, such as sheet metal car parts forming part of the exterior of the car. Actually, the use of the hand-held car window cleaning tool 1 is not restricted to cars. For example, it can be used for cleaning other vehicles, e.g. motorbikes, or other objects or items.

In the shown embodiment, said frame part 2 is provided with three scraper blades 3, a squeegee blade 4, and a sponge 5. However, in alternative embodiments, the frame part 2 may lack one or more of the cleaning utensils 3, 4, 5 shown here. Additionally or alternatively, the frame part 2 may be provided with one or multiple other cleaning utensils, such as for instance a brush.

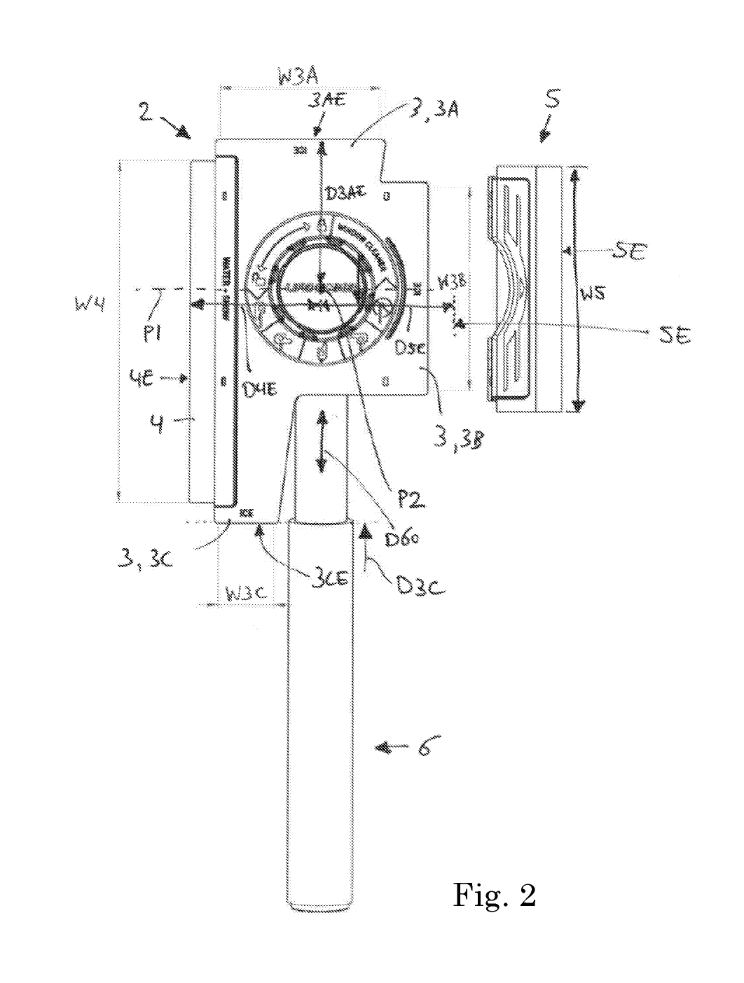

FIG. 2 shows a schematic perspective view of the embodiment of the hand-held car window cleaning tool 1 of FIG. 1 with its sponge 5 detached from the frame part 2. It is noted that the sponge 5 can be releasably attached to the frame part 2, e.g. by snapping a support part 5s of said sponge 5 onto the frame part 2, in particular onto a respective one 3B of the scraper blades 3. Additionally or alternatively, one or more of the other cleaning utensils 3A, 3B, 3C, 4 may be releasably attachable to the frame part 2.

As can be seen relatively well in FIG. 2, different cleaning utensils 3A, 3B, 3C, 4, 5 may have different widths W3A, W3B, W3C, W4, W5. For example, the squeegee blade 4 may be wider than the sponge 5. Additionally or alternatively, a scraper blade 3 may be provided with a width W3A, W3C smaller than the width W4 of the squeegee blade 4, and preferably also smaller than the width W5 of the sponge 5. A relatively wide squeegee blade 4 may facilitate that water can be removed from car surfaces relatively swiftly, whereas a less wide sponge 5 and/or less wide scraper blade 3 may facilitate that relatively much force can be applied to a relatively small surface area, for instance when vigorously scrubbing by means of the sponge 5 and/or when scraping off frost, ice and/or snow by means of a respective scraper blade 3.

Further, a cleaning utensils 3, 4, 5 having a relatively small width may be helpful in order to clean small surfaces, in particular surfaces which are relatively difficult to reach and/or which are enclosed at least partly, such as for instance a mirror glass surface bounded by an edge of a mirror housing of a wing mirror. For example to facilitate cleaning such small surfaces, it may be advantageous to provide the frame part 2 with a relatively narrow cleaning utensil 3, 4, 5, in particular a relatively narrow scraper blade 3C.

The hand-held car window cleaning tool 1 further comprises a handle 6 attached to said frame part 2. The tool 1 is arranged such that the position of the frame part 2 is adjustable with respect to said handle 6. In the shown embodiment, the frame part 2 is pivotably connected to the handle 6, in particular to a distal end region 60 of said handle 6. The handle may be elongate, and may for instance be rod shaped and/or formed as a shaft or pole, e.g. a telescopic shaft. Additionally or alternatively, the handle 6 may be provided with a handgrip 64, which for instance may comprise a relatively outer surface rough and/or resiliently compressible material, e.g. in order to provide relatively much traction. For example, the handgrip 64, which may be provided at a proximal end region 67 of the handle 6, may comprise a rubber material, rubber like material, foam material and/or foam like material, which for instance may be formed as a cover or cover layer, e.g. covering at least a part of a telescopic segment 63E of said handle 6.

For example in order to adjust the tool 1, the frame part 2 may be pivoted about a first pivot axis P1. Advantageously, said first pivot axis P1 may extend substantially transverse to a direction D60 in which said distal end region 60 of the handle 6 extends. It is noted that substantially transverse may be explained as at least meaning that an angle between said direction D60 and said first pivot axis P1 may be between 70° and 110°, preferably between 80° and 100°, or between 85° and 95°, such as about 90°.

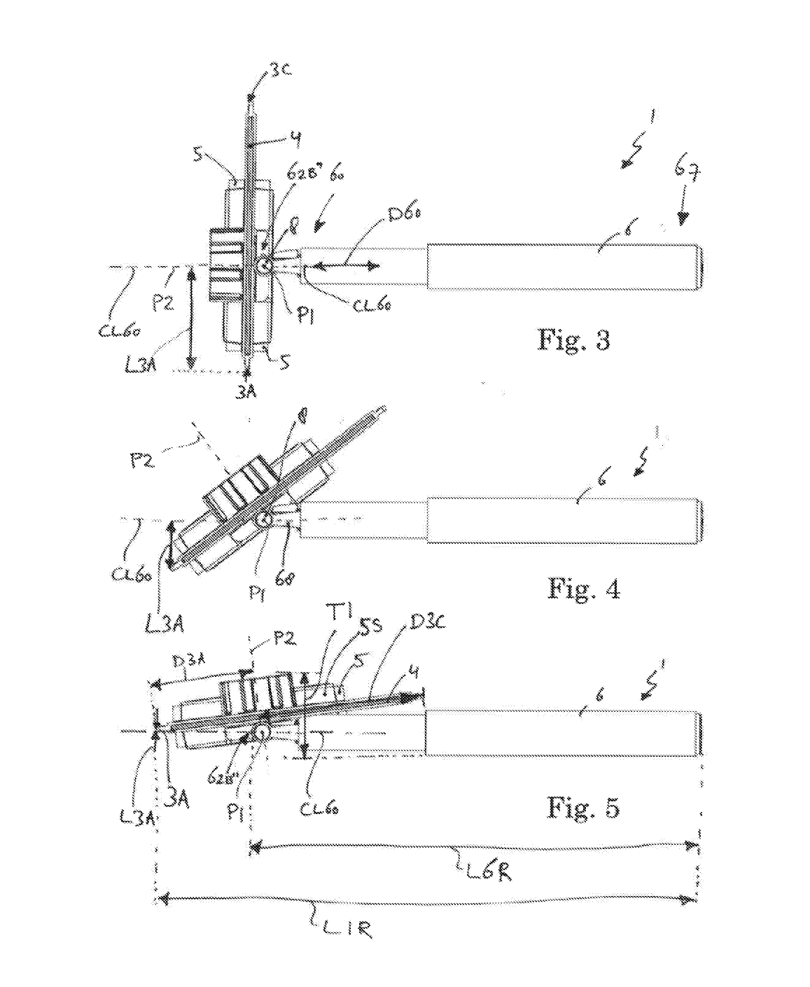

FIG. 3, FIG. 4 and FIG. 5 show schematic side views of the cleaning tool 1 with its frame part 2 in three different positions with respect to the handle 6. In FIG. 3, the frame part 2 is in same first position as in FIG. 1, whereas FIG. 5 shows the frame part 2 in the same second position as in FIG. 2. FIG. 4 shows the frame part 2 located in an intermediate adjustment position between the first position of FIG. 3 and the second position of FIG. 4.

The tool 1 may be arranged such that, at least in the first position (see e.g. FIG. 3) of the frame part 2, the at least one of the scraper blade 3, the squeegee blade 4 and the sponge 5 can extend substantially parallel with the first pivot axis P1. It is noted that substantially parallel may be explained as at least meaning that an angle between said first pivot axis P1 and the respective cleaning utensil may be at most 20°, preferably at most 15° or at most 10°, for instance not more than 5°.

As can be understood from FIGS. 3-5, the tool 1 may also be arranged such that, upon pivoting the frame part 2 about the first pivot axis P1, the length L3A of the shortest distance between said at least one 3A of the scraper blade 3A-3C, the squeegee blade 4 and the sponge 5 on the one hand, and an imaginary center line CL60 of the distal end region 60 of the handle 6 on the other hand, changes. For example, an angle between a lateral direction of the frame part 2 on the one hand, and the imaginary center line CL60 of the distal end region 60 of the handle 6 on the other hand, may lie between 2° or at most 25°, preferably below 20°, more preferably below 15°, such as between 10° and 5°, for instance about 7.5°.

Advantageously, in the second position (see e.g. FIG. 5) of the frame part 2, said imaginary center line CL60 of the distal end region 60 of the handle 6 substantially intersects with said at least one 3A of the scraper blade, the squeegee blade and the sponge, which said at least one 3A then thus may extend substantially parallel with the first pivot axis P1. In said second position (see e.g. FIG. 3) of the frame part 2, the length L3A of the shortest distance between said at least one 3A of the scraper blade, the squeegee blade and the sponge on the one hand, and an imaginary center line CL60 of the distal end region 60 of the handle 6 on the other hand, can thus be relatively small, in particular substantially non-existent, such as for instance no more than 2 cm, preferably no more than 15 mm, such as for example at most 10 mm or at most 5 mm.

It will be appreciated that, in the first position (see e.g. FIG. 3) of the frame part 2, in which the frame part 2 has been pivoted about the first pivot axis P1 with respect to said second position (see e.g. FIG. 5), the said one 3A of said at least one of the scraper blade 3, the squeegee blade 4 and the sponge 5 is offset from said imaginary center line CL60 of the distal end region 60 of the handle 6.

By having the frame part 2 of the tool 1 in a position (for example see FIG. 3) in which the respective cleaning utensil 3A one wants to use is offset from the imaginary center line CL60 of the distal end region 60 of the handle 6, it can be counteracted that the handle 6, or at least that the distal end region 60 thereof, will unintentionally impinges upon the car when said respective utensil 3A is used. In this context, it is noted that this may especially be the case when a user holds the tool 1 at a proximal end region 67, in particular in case send proximal end region 67 is located relatively far away from the frame part 2, such as for instance is the case when the handle 6 is relatively long.

On the other hand, by having the frame part 2 of the tool 1 in a position (for example see FIG. 5) in which the respective cleaning utensil 3A one wants to use is less far offset from the imaginary center line CL60 of the distal end region 60 of the handle 6, or is even intersecting with said center line CL 60, it can be facilitated relatively well that a user can apply relatively much force in a relatively controlled manner.

In preferred embodiments, such for instance in the here shown embodiment, the hand-held cleaning tool 1 can further be arranged such that the frame part 2 is pivotable with respect to the handle 6 about a second pivot axis P2. Advantageously, the direction of the first pivot axis P1 and the direction of the second pivot axis P2 may intersect, such as is the case in the shown embodiment, or may form skew lines.

Preferably, the first pivot axis P1 and the second pivot axis P2 may extend substantially transverse to each other. In case the pivot axes P1, P2 intersect, an angle therebetween may for instance be between 70° and 110°, preferably between 80° and 100°, or between 85° and 95°, such as about 90°. In case the pivot axes P1, P2 form skew lines, an angle between said pivot axes may, when seen from the direction in which the shortest distance between said two skew lines extends, for instance be between 70° and 110°, preferably between 80° and 100°, or between 85° and 95°, such as about 90°.

In case at least in one position of the frame part 2, e.g. in the second position (see e.g. FIG. 5) of the frame part 2, the at least one 3A of the scraper blade, the squeegee blade and the sponge extends substantially parallel with the first pivot axis P1, said frame part 2 can, upon pivoting the frame part 2 about said second pivot axis P2, be brought in a further position (not shown) in which said one 3A of the at least one of the scraper blade 3A-3C, the squeegee blade 4 and the sponge 5 is no longer extending substantially parallel with the first pivot axis P1. Preferably, in particular in a case the frame part 2 is provided with at least two cleaning utensils 3, 4, 5, another one said at least two cleaning utensils may then extend substantially parallel with the first pivot axis P1 in said further position of the frame part 2, for example in order to use said other cleaning utensil in a manner in which the user can apply relatively much force in a relatively controlled manner. Advantageously, the length of the shortest distance between the imaginary center line CL60 of the of the distal end region 60 of the handle 6 on the one hand, and said other cleaning utensil on the other hand, may be relatively small, in particular substantially non-existent, such as for instance no more than 2 cm, preferably no more than 15 mm, such as for example at most 10 mm or at most 5 mm.

For instance thereto, the shortest distance D4E, D3AE, D5E between a working edge 4E, 3AE, 5E of a respective cleaning utensil 4, 3A, 5 and the second pivot axis P2 may be substantially the same for at least a number of the cleaning utensil 4, 3A, 5, at least when the respective cleaning utensil 5 is present at the frame part 2. Additionally or alternatively, having the shortest distance D4E, D3AE, D5E between a working edge 4E, 3AE, 5E of a respective cleaning utensil 4, 3A, 5 and the second pivot axis P2 substantially similar for at least a number of the cleaning utensil 4, 3A, 5, can facilitate that in the first position (see e.g. FIGS. 1, 3 and 8) of the frame part 2, multiple ones 3A, 4, 5 of said cleaning utensils can be located about the same distance from the imaginary center line CL60. This may facilitate that the handle 6, or at least a distal end region 60 thereof, can be kept at distance from the car surface to be cleaned, irrespectively of which of said respective multiple ones 3A, 4, 5 of said cleaning utensils is being used.

It is noted that one 3C or more of the cleaning utensils 3-5 may have a working edge or cleaning edge 3CE that is located at a substantially different distance from the second pivot axis P2, in particular located substantially further away from said second pivot axis P2, for instance in order to facilitate that another one 4 of the cleaning utensils can be made relatively wide. It will be appreciated that, at least in embodiments, such a cleaning utensil 3C being located further away from the second pivot axis P2 may be located relatively far away from the imaginary center line CL60 of the of the distal end region 60 of the handle 6 in a toppled position of the frame part 2. Therefore, it may be advantageous to choose a cleaning utensil 3C having a relatively small width W3C as a, or as the, cleaning utensil having a relatively large shortest distance D3C to the second pivot axis P2. In embodiments, the frame part 2 may for example be substantially L-shaped.

Advantageously, the longitudinal direction of said one of the at least one of the scraper blade 3, the squeegee blade 4 and the sponge 5 on the one hand and the direction of the first pivot axis P1 on the other hand can intersect or can form skew lines in said further position of the frame part 2.

The hand-held cleaning tool 1 may be provided with at least one releasable lock 7 for locking the position of the frame part 2 with respect to the handle 6. For example, a first lock may be provided to prevent the frame part 2 from pivoting about the first pivot axis P1, and/or second lock may be provided to prevent the frame part 2 from pivoting about the second pivot axis P2.

Advantageously, at least one lock 7 can be provided, which lock 7 is arranged for releasably locking the position of the frame part 2 both with respect to first pivot axis P1 and with respect to the second pivot axis P2.

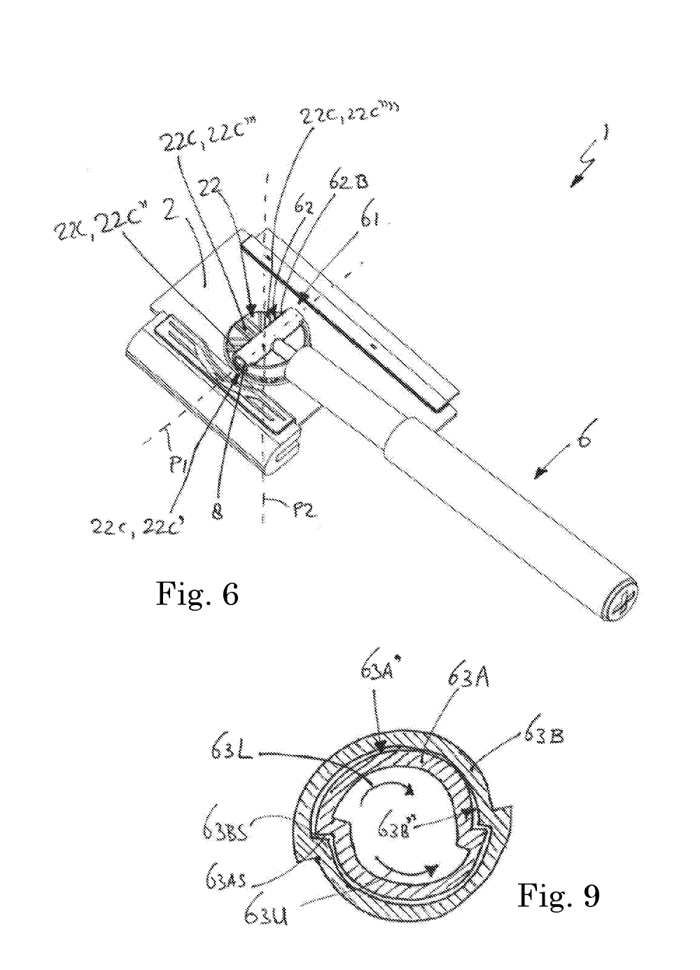

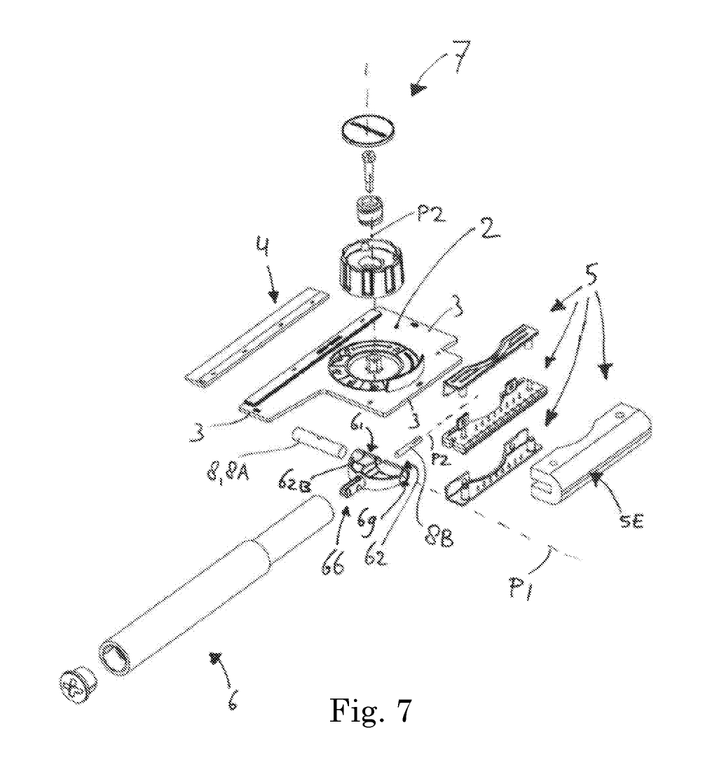

In embodiments, such as in the embodiment shown here, as best can be seen in FIGS. 6 and 7, a distal end 61 of the handle 6 can be provided with a first surface 62 and the frame part 2 can be provided with a second surface 22, wherein said first surface 62 and said second surface 22 are formed as uneven surfaces. Each of said surfaces 22, 62 can be provided with one or more protrusions 62B, bulges 62B, or the like, which for instance may comprise ridges 62B, and/or with one or more indentations 22C, depressions 22C, cavities 22C, recesses 22C, or the like, such as grooves 22C or channels 22C, wherein said uneven surfaces 22, 62 can be arranged to lockingly engage each other when pressed against each other. Advantageously, the lock 7 or a clamp may keep said cooperating first and second surfaces 22, 62 pressed against each other in a locking position of the tool 1.

As for instance may be understood from FIGS. 3-6, the first surface 62 may be convex and/or substantially cylindrical. The second surface 22 can be provided with corresponding concave indentations 22C, which may be substantially cylindrical as well. Once the convex cylindrical outer 62 surface 72 is located within such a corresponding concave cylindrical indentation 22C, the engagement between said surfaces 22, 62 may counteract that the frame part 2 can rotate about the second pivot axis P2, as may be understood from FIG. 6. By further providing said substantially cylindrical surface 62 by a protrusion 62B and by providing the substantially cylindrical channel 22C with a groove corresponding with said protrusion 62B, it can be counteracted that the frame part 2 unintentionally tilts with respect to the first pivot axis P1.

Although, in the shown embodiment, the first surface 62 comprises protrusions 62B to cooperate with corresponding indentations 22C in the second surface 22 provided by the frame part 2, this may in other embodiments be different. For example, the first surface 62 may comprise indentations and the second surface 22 may comprise corresponding protrusions.

Here, the frame part 2 can be locked in two positions with respect to the handle 6 with respect to the first pivot axis P1 (see FIG. 3 and FIG. 5). Thereto, the shown embodiment of the tool 1 comprises two ridges 62B′, 62B″, which can be seen in FIGS. 3-7. In the first position (see FIG. 3) of the frame part 2, a first one 62B′ of said ridges cooperates with a groove 22C in the second surface 22. In the second position (see FIG. 5) of the frame part 2, a second one 62B″ of said ridges cooperates with said same groove 22C in the second surface 22. In order to pivot the frame part 2 about the first pivot axis P1 from the first position (see FIG. 3) towards the second position (see FIG. 5), the lock 7 may be released such that the first and second surfaces 62, 22 are not longer pressed against each other and the engagement may be released by lifting the frame part 2, and thereby the uneven second surface 22, to some extent from the first surface 62 located at the distal end 61 of the handle 6, such that the frame part 2 can be pivoted about the first pivot axis P1 (see FIG. 4).

In the shown embodiment, frame part 2 is also pivotable with respect to the handle 6 about the second pivot axis P2, and the first and second surfaces 62, 22, when pressed against each other, are also cooperating to lockingly engage each other, thereby substantially preventing substantive movement of the frame part 2 with respect to the second pivot axis P2. The tool 1 may be arranged such that the frame plate 2 can be locked with respect to pivot axis P2 in a number of different rotational positions. Thereto, such as can be seen in FIG. 6, the second surface 22 may be provided with multiple irregularities, e.g. multiple indentations 22C, such as multiple grooves 22C′, 22C″, 22C′″, 22C″ or gutters. The angles between two respective ones of said multiple grooves may for example correspond with angles between two respective ones of the cleaning utensils 3, 4, 5. Here, two respective cleaning utensils are substantially at right angles, and two corresponding grooves 22C′, 22C′″ can then also be substantially at right angles with respect to each other. Additionally or alternatively, the frame part 2 may be positioned in different rotational positions with respect to the second pivot axis 2, for example by means of other grooves 22C″, 22C″.

Advantageously, the hand-held cleaning tool 1 may comprise an intermediate part 8. Said intermediate part 8 may be pivotably connected to the handle 6, in particular to a distal end 61 of the handle 6, about the first pivot axis P1. Here, as for instance can be seen in the schematic exploded view shown in FIG. 7, the intermediate part 8 comprises a rod 8A or tube which is mounted in a cylindrically-shaped receiving opening 69 in the distal end 61 of the handle 6. Here, said distal end 61 is formed by an end piece 66 of the handle, formed as a separate part, which is mounted to the distal end of a telescopic segment 63A of the handle.

Further, the frame part 2 can be pivotably connected to the intermediate part 8 about the second pivot axis P2. Here, the intermediate part 8 comprises a pivot shaft 8B about which the frame part 2 can be pivoted. The distal end 61 of the handle 6 is provided with an opening, in particular a slot 69, for conducting the pivot shaft 8B when the intermediate part 8, and the thereto attached frame part 2, are pivot about first pivot axis P1.

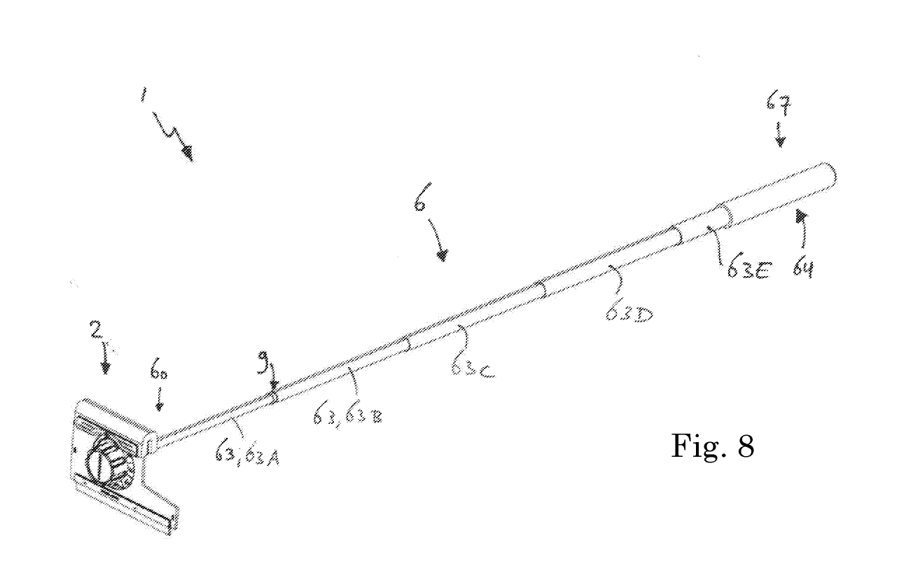

Additionally or alternatively, the handle 6 may be extendible. In FIG. 8, the tool 1 is shown with its telescopic handle 6 in an extended state. In such extended state, in particular in its furthest extended state, the handle 6 may be relatively long, preferably at least 90 cm long, more preferably at least 1 meter long, such as for instance at least 1.1 meter long. Including the frame part 2 provided with the at least one cleaning utensil 3, 4, 5, the total length of the tool 1 can be even longer when the handle 6 is in its maximum extended state or position. For instance, one or more telescopic segments 63A, 63B, that in the completely expanded state of the handle 6 are located at the distal end side of the handle, may be relatively thin with respect to the other telescopic segments 63C-63E, and may be less strong. For example, one or more segments, in particular the last two segments 63A, 63B, may be marked to show a user that they are not intended for heavy-duty use. Advantageously, such less firm segments telescopic segments 63A, 63B may have a substantially different color than the other segments 63C, 63D, 63E, in particular a color serving as a signal color or warning color, e.g. a substantially yellow, orange or red color to attract the attention of a user. Additionally or alternatively, the tool 1, in particular its handle, more in particular the less firm segment, or one of the less firm segments, may be provided with information to inform the user that said less firm segment(s) are not intended for heavy-duty use, such as for instance firm scrubbing.

In a retracted state or position of the telescopic handle 6 (see e.g. FIG. 5), the length L6R of the handle may be relatively short, e.g. being at most 40 cm, but preferably even shorter, such as no more than 30 cm.

For example, the telescopic handle 6 may comprise at least four, preferably at least five segments 63A, 63B, 63C, 63D, 63E. By enabling the handle to be extended to a relatively large length (see e.g. FIG. 8), the tool 1 may facilitate cleaning more distant spots, such as for instance a moon roof or another window-like glass panel in the roof of a car. By enabling that the handle can be slid in, the tool 1 can be brought into a compact state, which may facilitate it to be stored relatively easily, e.g. in a relatively small place, such as for instance a glove compartment of a car. For example in order to facilitate storing of the tool 1, it may be advantageous if the frame part 2 provided with the one or more cleaning utensils 3-5 can be brought into a position in which said frame part 2 does not extend away from the handle 6 in a lateral direction of said handle to too great extent. As can be seen in FIG. 5, the frame part 2 may be brought into its second position in order to do so. Preferably, the height T1 or thickness T1 of the tool 1 may then be relatively small, e.g. less than 10 cm, preferably less than 7 cm, such as about 5 cm. Advantageously, the total length L1R of the folded in tool 1 may be relatively small, e.g. less than 50 cm, preferably less than 45 cm, more preferably even under 40 cm, such as for instance about 36 cm.

For example to counteract that the handle 6 slides out unintentionally when not in use, the hand-held car cleaning tool 1 may be arranged to temporarily lock segments 63 of its telescopic handle 6 from sliding with respect to each other. Additionally or alternatively, locking the segments 63A-63E with respect to each other may counteract that the handle 6 slides in unintentionally, in particular when a certain amount of force is applied, for example during scrubbing vigorously.

In advantageous embodiments, each of the segments of such telescopic handle may be locked with respect to the subsequent segment, preferably both in its most expanded position as well as in its retracted or folded-in position.

Additionally, the segments may be lockable with respect to each other in intermediate positions, e.g. a position in which one segment is only slit out partly with respect to its adjacent (outwardly placed) segment. As a result, it can be facilitated that a user may set the total length of the handle to any desired length between the maximum handle length that corresponds with a completely expanded handle and the minimum handle length that corresponds with a completely slit in handle.

For instance thereto, as can be seen in FIG. 9, which shows a cross-sectional view of the handle 6 along at location 9 in FIG. 8, the cross-section of the outer surface 63A′ of an inner segment 63A of the telescopic handle 6 and the cross-section of the inner surface 63B″ of an outwardly located subsequent telescopic handle segment 63B are formed such that twisting one 63A of said inner and outer segments with respect to the other one 63B in one direction 63L causes said outer surface 63A′ and said inner surface 63B″ to frictionally engage each other such as to clamp said segments 63A, 63B onto each other thereby counteracting sliding of the respective inner segment 63A with respect to the respective outer segment 63B, whereas twisting said one segment 63A with respect to the other segment 63B in the opposite direction 63U releases the frictional clamp thereby allowing the sliding of the inner segment with respect to the outer segment. As can further be seen in FIG. 9, the cross-sections 63A′, 63B″ can be provided with one or more stop surfaces 63AS, 63BS that can cooperate with each other to limit the twisting when the telescopic handle segments 63A, 63B are unlocked with respect to each other.

It is noted that for the purpose of clarity and a concise description features are described herein as part of the same or separate embodiments, however, it will be appreciated that the scope of the invention may include embodiments having combinations of all or some of the features described.

The disclosed embodiments are illustrative, not restrictive. While specific configurations of the hand-held car window cleaning tool have been described, it is understood that the present invention can be applied to a wide variety of hand-held car window cleaning tools. There are many alternative ways of implementing the invention.

It is noted that the invention is not restricted to the embodiments described and shown herein. It will be understood that many variants are possible. The variants will be apparent for the person skilled in the art and are considered to lie within the scope of the invention as formulated in the following claims.

What is claimed is:

1. A hand-held car window cleaning tool, comprising:
a frame part provided with at least one of:
a scraper blade for removing frost, ice or snow;
a squeegee blade for removing liquid, dirt or snow; and
a sponge; and
a handle attached to said frame part,
wherein the hand-held cleaning tool is arranged such that the position of the frame part is adjustable with respect to the handle.

2. The hand-held car window cleaning tool according to claim 1, wherein the frame part is pivotably connected to the handle by means of at least a first pivot axis.

3. The hand-held cleaning tool according to claim 2, wherein a distal end region of the handle is attached to the frame part, and wherein the first pivot axis extends substantially transverse to a direction in which said distal end region of the handle extends.

4. The hand-held cleaning tool according to claim 3,
wherein, at least in a position of the frame part, the at least one of the scraper blade, the squeegee blade and the sponge extends substantially parallel with the first pivot axis; and
wherein, upon pivoting the frame part about the first pivot axis, the length of the shortest distance between said at least one of the scraper blade, the squeegee blade and the sponge on the one hand, and an imaginary center line of the distal end region of the handle on the other hand, changes.

5. The hand-held cleaning tool according to claim 4, wherein, in said position of the frame part, said imaginary center line of the distal end region of the handle substantially intersects with said at least one of the scraper blade, the squeegee blade and the sponge.

6. The hand-held cleaning tool according to claim 3,
wherein the hand-held cleaning tool further is arranged such that the frame part is pivotable with respect to the handle about a second pivot axis;
wherein, at least in a position of the frame part, the at least one of the scraper blade, the squeegee blade and the sponge extends substantially parallel with the first pivot axis; and
wherein, upon pivoting the frame part about the second pivot axis, said frame part has been brought in a further position in which said one of the at least one of the scraper blade, the squeegee blade and the sponge is no longer extending substantially parallel with the first pivot axis.

7. The hand-held cleaning tool according to claim 1, the hand-held cleaning tool being arranged such that the frame part is pivotable with respect to the handle about a first pivot axis, the hand-held cleaning tool further being arranged such that the frame part is pivotable with respect to the handle about a second pivot axis.

8. The hand-held cleaning tool according to claim 7, wherein the direction of the first pivot axis and the direction of the second pivot axis intersect or form skew lines.

9. The hand-held cleaning tool according to claim 7, wherein the first pivot axis extends substantially transverse with respect to the second pivot axis.

10. The hand-held cleaning tool according to claim 1, further comprising at least one releasable lock for locking the position of the frame part with respect to the handle.

11. The hand-held cleaning tool according to claim 7, further comprising at least one lock, which lock is arranged for releasably locking the position of the frame part both with respect to first pivot axis and with respect to the second pivot axis.

12. The hand-held cleaning tool according to claim 1, further comprising an intermediate part, the intermediate part pivotably connected to the handle about a first pivot axis, and the frame part being pivotably connected to the intermediate part about a second pivot axis

13. The hand-held cleaning tool according to claim 1, wherein a distal end of the handle is provided with a first surface and the frame part is provided with a second surface, wherein said first surface and said second surface are formed as uneven surfaces, each provided with one or more protrusions and/or one or more indentations, wherein said uneven surfaces are arranged to lockingly engage each other when pressed against each other.

14. The hand-held cleaning tool according to claim 13, further comprising a lock or a clamp for keeping said first surface and said second surface pressed against each other in a locking position of the tool.

15. The hand-held cleaning tool according to claim 13, wherein the hand-held cleaning tool is arranged such that the frame part is pivotable with respect to the handle about a first pivot axis, the hand-held cleaning tool further being arranged such that the frame part is pivotable with respect to the handle about a second pivot axis, and wherein the first surface and the second surface are arranged to lockingly engage each other in such manner, when pressed against each other, that said surfaces, when lockingly engaged, substantially prevent substantive movement of the frame part with respect to both the first pivot axis and the second pivot axis.

16. The hand-held cleaning tool according to claim 1, wherein the handle is a telescopic handle, wherein the handle is arranged to temporarily lock segments of the telescopic handle from sliding with respect to each other.

17. The hand-held cleaning tool according to claim 16, wherein the cross-section of the outer surface of an inner segment of the telescopic handle and the cross-section of the inner surface of an outer segment of said telescopic handle are formed such that twisting one of said inner and outer segment with respect to the other one thereof in one direction causes said outer surface and said inner surface to frictionally engage each other such as to clamp said segments onto each other thereby counteracting sliding of the inner segment with respect to the outer segment, whereas twisting said one segment with respect to the other segment in the opposite direction releases the frictional clamp thereby allowing the sliding of the inner segment with respect to the outer segment.
